(19) United States
(12) Patent Application Publication
(10) Pub. No.: US 2012/0284474 A1
(43) Pub. Date: Nov. 8, 2012

(54) ENABLING RECOVERY DURING DATA DEFRAGMENTATION

(75) Inventors: DOUGLAS L. LEHR, AUSTIN, TX (US); FRANKLIN E. McCUNE, TUCSON, AZ (US); DAVID C. REED, TUCSON, AZ (US); MAX D. SMITH, TUCSON, AZ (US)

(73) Assignee: INTERNATIONAL BUSINESS MACHINES CORPORATION, ARMONK, NY (US)

(21) Appl. No.: 13/102,882

(22) Filed: May 6, 2011

(51) Int. Cl. G06F 12/02

(52) U.S. Cl. 711/165; 711/E12.002

(57) ABSTRACT

In defragmentation of data of a data storage system, the data storage system having at least one storage control and data storage, allowing defragmentation of data with respect to the data storage, the defragmentation comprising analysis and data movement. During the defragmentation and before completion of the defragmentation, in response to the data movement reaching a stable state, further defragmentation analysis and data movement is interrupted; making a point-in-time copy of the data subject to the defragmentation; and resuming the defragmentation analysis and data movement. At a further stable state where a new point-in-time copy is made, an earlier point-in-time copy is withdrawn. Should the defragmentation process end prematurely, a backup of the data subject to defragmentation may be recovered from a most recent point-in-time copy.

### FIELD OF THE INVENTION

This invention relates to computer-implemented data storage, and more particularly to defragmentation of data with respect to such data storage.

### DOCUMENTS INCORPORATED BY REFERENCE

Commonly assigned U.S. Pat. No. 6,611,901, Issued Aug. 26, 2003, and U.S. Pat. No. 5,263,154, Reissued Mar. 19, 2002 as U.S. patent RE 37601, are incorporated for their showings of point-in-time copy systems.

### BACKGROUND OF THE INVENTION

Updating data storage on serial devices of a data storage system, two examples of which are disk storage and RAID (Redundant Array of Independent Disks) system, typically results in a phenomenon known as fragmentation to occur. For example, when a file, such as a volume, is first created, the computer-implemented system will cause the file to be allocated to a contiguous area, such as a series of tracks or cylinders on the disk or RAID system, if it is possible to get the contiguous area. However, when the user adds data or updates data of a first file, some additional space at another physical location on the disk is allocated for the addition or update, and the outdated portion of the file may be deleted, resulting in fragmentation of the data both of the original file due to the deletion and of the added or updated data due to the placement of the data.

Fragmentation tends to build up over time as more data and files are added, deleted and modified. Hence, defragmentation algorithms have been developed to analyze the fragmented data and move data in such a way as to place portions of data in deleted areas to reorganize the data, making the data both more contiguous and in the proper sequence. This typically cannot be done in a single pass of the data, but requires several or many passes to complete a total defragmentation of the data. A few of the numerous examples of defragmentation algorithms comprise “Real Time Defrag” of Dino Software, “Compaktor” of Computer Associates, and “DFDSS Defrag” of International Business Machines Corp.

### SUMMARY OF THE INVENTION

Methods, data storage systems and computer program products are provided to respond to defragmentation of data of a data storage system.

In one embodiment, in a computer-implemented data storage system comprising at least one storage control and data storage, the following is performed:

allowing defragmentation of data with respect to the data storage, the defragmentation comprising analysis and data movement;

during the defragmentation and before completion of the defragmentation, in response to the data movement reaching a stable state, interrupting further defragmentation analysis and data movement;

making a point-in-time copy of the data subject to the defragmentation; and

resuming the defragmentation analysis and data movement.

In a further embodiment, the stable state comprises a temporary state of the storage control and data storage wherein data movement in accordance with a data analysis is complete.

In a still further embodiment, the stable state comprises completion of updating a volume table of contents with respect to the data movement.

In another embodiment, the stable state comprises a temporary state of the storage control and data storage wherein the data movement has completed such that it is in synchronization with the data analysis.

In a further embodiment, the synchronization comprises, for a volume of data, during data movement, determining whether a volume table of contents, VSAM volume data set, and data set extents on the volume are in synchronization.

In another embodiment, subsequent to an early point-in-time copy and subsequent to the data movement reaching a further stable state, the early point-in-time copy is withdrawn.

A further embodiment additionally comprises, in response to a premature end to the defragmentation process with respect to the data, making a backup of the data subject to defragmentation from a most recent point-in-time copy. The backup may be employed for recovery of the data.

For a fuller understanding of the present invention, reference should be made to the following detailed description taken in conjunction with the accompanying drawings.

### BRIEF DESCRIPTION OF THE DRAWINGS

FIG. 1 is a high-level block diagram showing one embodiment of a computer-implemented system made up of different types of computing and data storage devices;

FIG. 2 is a high-level block diagram showing one embodiment of a computer-implemented system for providing point-in-time copies of data during defragmentation of at least one of the data storage devices of FIG. 1; and

FIG. 3 is a flow diagram showing one embodiment of a method for providing point-in-time copies of data during defragmentation of at least one of the data storage devices of FIG. 1.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

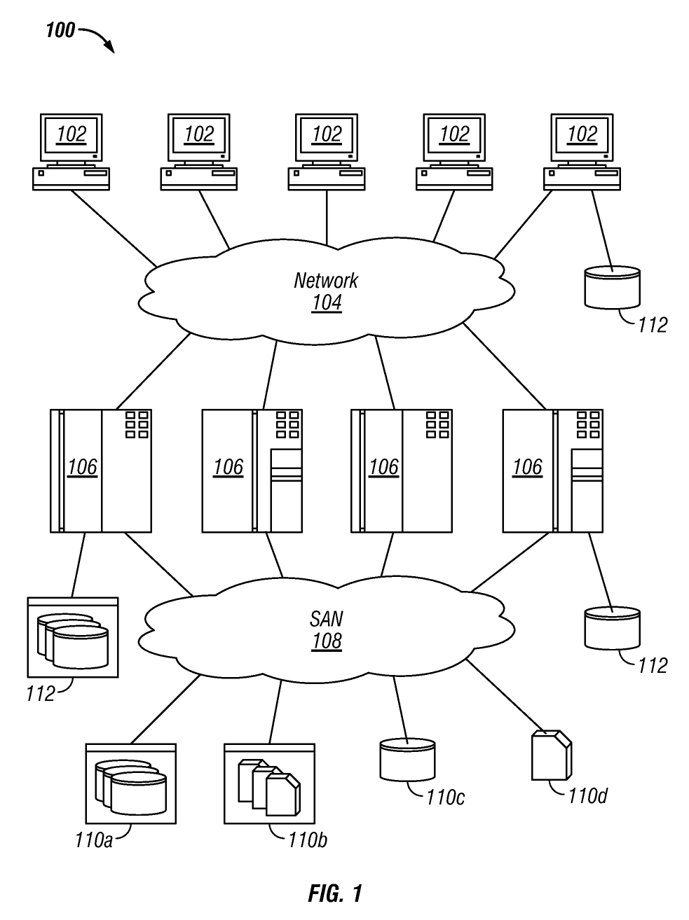

Referring to FIG. 1, an example of a computer-implemented system 100 is illustrated. The system is one of many computer-implemented systems which may implement the present invention to provide point-in-time copies of data during defragmentation of at least one of the data storage devices in the system. The system architecture 100 is presented to show various types of computing devices that may benefit from the apparatus and methods disclosed herein. The system architecture 100 is presented only by way of example and is not intended to be limiting. Indeed, the apparatus and methods disclosed herein may be applicable to a wide variety of different computing devices and is not limited to those illustrated herein.

As shown, the exemplary system architecture 100 includes one or more computer processors 102, 106 interconnected by a network 104. The network 104 may include, for example, a local-area-network (LAN), a wide-area-network (WAN), the Internet, an intranet, or the like. In certain embodiments, the computer processors 102, 106 may include both client computer processors 102 and server computer processors 106. In the example, the client computers 102 initiate communication sessions, whereas the server computer processors 106 wait for requests from the client computer processors 102. In certain embodiments, the computer processors 102 and/or server processors 106 may connect to one or more internal or external data storage systems 112 (e.g., hard-disk drives, solid-state drives, tape drives, libraries, etc.). These computer processors 102, 106 and direct-attached storage systems 112 may communicate using protocols such as ATA, SATA, SCSI, SAS, Fibre Channel, or the like.

The system architecture 100 may, in certain embodiments, include a storage network 108 behind the server processors 106, such as a storage-area-network (SAN) or a LAN (e.g., when using network-attached storage). This network 108 may connect the server processors 106 to one or more data storage systems 110, such as arrays 110a of hard-disk drives or solid-state drives, including RAID (Redundant Array of Independent Disks) arrays, tape libraries 110b, individual hard-disk drives 110c or solid-state drives 110c, tape drives or libraries 110d, CD-ROM libraries, virtual tape libraries, or the like. To access a storage system 110, a server processor 106 may communicate over physical connections from one or more ports on the server processor 106 to one or more ports on the storage system 110. A connection may be through a switch, fabric, direct connection, or the like. In certain embodiments, the server processors 106 and storage systems 110 may communicate using a networking standard such as Fibre Channel (FC).

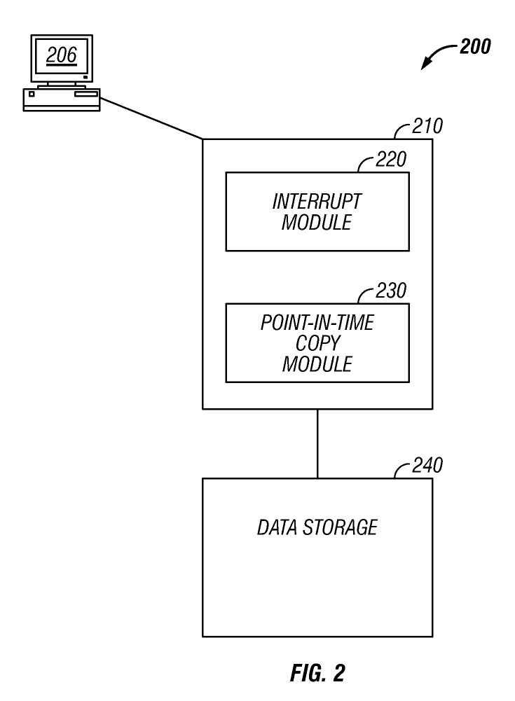

Referring to FIG. 2, one embodiment of a computer-implemented system 200 for providing point-in-time copies of data during defragmentation of at least one of the data storage devices of FIG. 1 is illustrated. The computer-implemented system 200 may be implemented in any of the devices or systems of FIG. 1, including a client system 102, a server processor 106, a storage system 110, and attached storage 112, or in another computer-implemented system connected via network 104. As shown, the computer-implemented system 200 comprises one or more modules to provide the point-in-time copies of data. The modules may be located at one or more computer processors and one or more associated computer-usable storage medium having non-transient computer-usable program code embodied therein. The details of the computer processors and computer-usable storage medium are discussed hereinafter. The computer-implemented system 200 may receive commands, information and the computer-usable program code, and provide commands, notifications and information to, one or more hosts or host terminals 206. These modules may be incorporated in or comprise applications of a storage control 210, comprising a stand alone unit or comprise a portion of the host, server processor, storage system or attached storage. The modules may comprise a module 220 to interface with the defragmentation application and a module 230 to provide a point-in-time copy. The computer-implemented system also comprises storage 240 to store the point-in-time copy.

Although illustrated as grouped together, the modules and other elements may be spread among various computer processors and systems, as discussed above. The modules of the computer-implemented system 200 also communicate with the data storage device or devices whose data is defragmented by the defragmentation application.

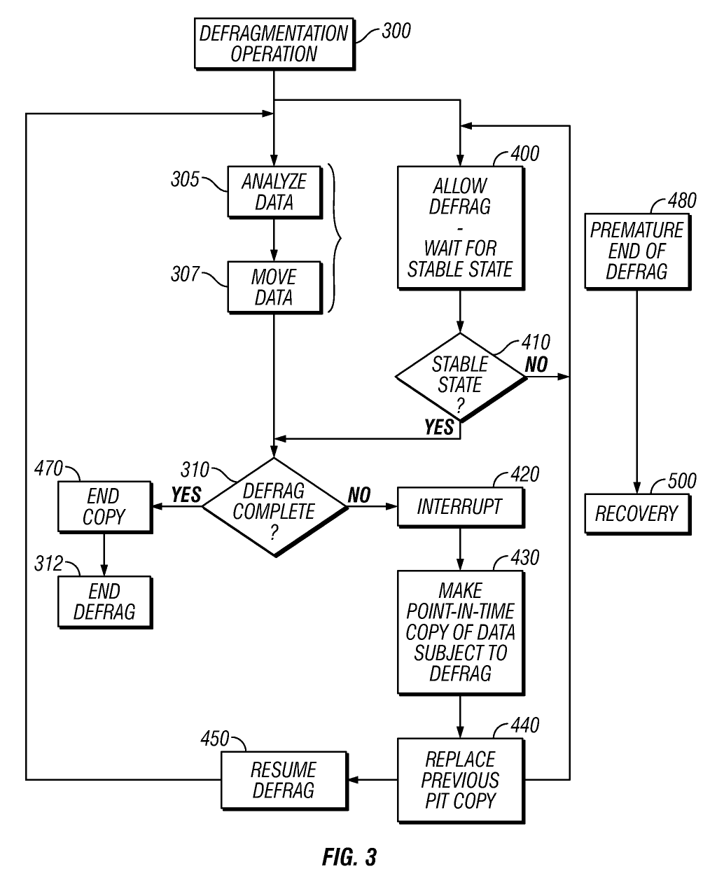

Referring to FIGS. 2 and 3, the present invention responds to the initiation of a defragmentation operation 300. As discussed above, defragmentation is an operation or process, often extended in time, that takes data that has been fragmented over time and analyzes the fragmented data in step 305 and moves data in step 307 in such a way as to place portions of data in deleted areas to reorganize the data to make the data both more contiguous and in the proper sequence. This typically cannot be done in a single pass of the data, but requires several or many passes to complete a total defragmentation of the data. A few of the numerous examples of defragmentation algorithms comprise “Real Time Defrag” of Dino Software, “Compaktor” of Computer Associates, and “DFDSS Defrag” of International Business Machines Corp.

A typical defragmentation operation 300 is performed by an application, for example, resident in a host system or processor 206 external to the data storage device whose data is being defragmented, such as a device forming storage system 110, or attached storage 112 of FIG. 1. The defragmentation operation may be performed on a specified volume of data of a data storage device, or may comprise all of the data on a data storage device or system, also defined herein as a “volume”.

Typically, the analysis of the data is conducted based on metadata and catalogs identifying the data and locations of the data, such as a volume table of contents (VTOC). The associations of the data may be further defined by a VSAM volume data set (VVDS) and are consulted to reorganize the data. Similar information is provided, for example by a file access table (FAT) in different environments.

Initiation of the defragmentation operation in step 300 may cause step 400 to initialize, which allows the defragmentation operation to begin and which waits for a stable state of the defragmentation operation.

Multiple passes of the defragmentation process are typically required to make the data contiguous to the desired level.

In some defragmentation operations, a pass comprises analyzing data and deleted areas, and reorganizing and moving blocks or units of data into available deleted areas. The data movement results in the deletion of areas from which the data has been moved. Another pass is made to analyze the data in its new state and the deleted areas and to continue the reorganization and move data into available deleted areas. A stable state may be reached at the end of a pass. The passes continue until a desired defragmentation reorganization level has been reached. For example, the defragmentation may be desired when the “fragmentation index” exceeds a certain value, and the desired defragmentation may be reached when the fragmentation index is reduced to another certain value.

In other defragmentation operations, multiple passes are not used in the same sense, and instead data blocks are moved continuously in accordance with an ongoing analysis. For this type of operation, a stable state is defined as a checkpoint when the volume table of contents, VSAM volume data set, and data set extents on the volume are in synchronization.

In the showing of FIG. 3, steps 305 and 307 represent a pass, and, if at the end of a pass, the defragmentation reorganization is complete as indicated by step 310, the defragmentation operation 300 is ended in step 312. If, at the end of a pass, further reorganization is desired, normally the next pass 305, 307 would be initiated. In the alternate type of defragmentation operation, steps 305 and 307 are continuous until step 310 indicates the reorganization is complete.

Step 410 determines if a desired stable state is reached in the defragmentation operation 305, 307. A stable state comprises a temporary state of the storage control and data storage wherein data movement in accordance with a data analysis is complete. If not, step 400 continues. If a stable state has been reached, step 310 determines whether the defragmentation operation for a volume is complete. If not, and more passes are required, step 420 interrupts the defragmentation operation.

Steps 410 and 420 may be implemented in various ways, for example, in one embodiment, the interrupt module 220 may comprise an interrupt placed in the defragmentation application at the point where the stable state is reached at the end of a pass 305, 307. As one example, the stable state comprises completion of updating a volume table of contents (VTOC) with respect to the data movement.

In another embodiment where the data blocks are moved continuously, the defragmentation operation may be monitored by the interrupt module 220 for a certain set of events indicating that the data movement has completed such that it is in synchronization with the data analysis. The interrupt is triggered upon the occurrence of the events such as when the volume table of contents (VTOC), VSAM volume data set (VVDS), and data set extents on the volume are in synchronization.

In another context, the equivalent of the VTOC is a file access table (FAT). In the second embodiment, it is possible that the synchronization of events may occur more often that desired for interrupts to occur. In such a situation, the interrupt module may count a number of occurrences of synchronization (such as 256) before activating the interrupt.

The interrupt module 220, in step 420, interrupts further defragmentation analysis and data movement 305, 307.

In step 430, point-in-time copy module 230 makes a point-in-time copy of the data subject to the defragmentation. Point-in-time copying creates an instant “virtual” copy of data by modifying metadata such as relationship tables or pointers to treat a source data object as both the original and copy. The point-in-time copy module 230 immediately reports creation of the copy without having made any physical copy of the data. Only a virtual copy has been created, called herein making the point-in-time copy. Later, as the defragmentation process 305, 307 resumes, the defragmentation process analyzes the data and the deleted areas and moves data into the deleted areas to make the data more contiguous as discussed above. However, the data that is “moved” into a deleted area still exists at the area that it was moved from. Thus, the virtual copy may be made into an actual, physical copy by using the existing metadata and pointers to access the data that was not moved and to access the moved data at the area from which it was moved.

Inventions and discussions of point-in-time copying in the art may focus further on situations where the data is updated, together with cross-referencing to the updates so that the updates can be tracked for both the original and the copy, which aspects are not important with respect to defragmentation since no updates to the data being moved are allowed.

At some point, the point-in-time module may begin to make an actual, physical copy of the original data object subject to defragmentation. This physical copy, if made, will become a backup copy as will be discussed.

Point-in-time copy module 230 may comprise any known point-in-time copy system of the “clone” type. As one example, International Business Machines Corporation has developed the “FlashCopy”® system as described, for example, in the incorporated U.S. Pat. No. 6,611,901 and U.S. RE 37601. The “clone” type of point-in-time copy results in the target holding a complete copy of the data that was on the source when the point-in-time copy was started.

Once the point-in-time copy of step 430 is made, the previous point-in-time copy, if any, is obsolete, and is withdrawn and replaced in step 440 by the present point-in-time copy, for example, by overwriting. The point-in-time copy information may be stored in data storage 240.

In step 450, the interrupt module 220 resumes the defragmentation process 305, 307.

The defragmentation operation continues, with the storage control 210 continuing to wait for a stable state 400, 410, interrupt the defragmentation process 420, initiate and make point-in-time copies of the data subject to the defragmentation 430, replacing obsolete point-in-time copies 440, and to resume the defragmentation process 450.

At some point, the defragmentation operation completes, as indicated by step 310. In response, the storage control 210, in step 470, ends the point-in-time copy process, and the defragmentation operation ends in step 312. Ending the point-in-time copy process may comprise terminating the process while leaving the last point-in-time copy information intact to be overwritten at the next process, or alternatively, may comprise marking the information as deleted.

The defragmentation operation may come to an end prematurely as shown by step 480. Examples of premature ends comprise an error event relating to the system or data subject to the defragmentation, or may comprise the user conducting an operation to interrupt or end the defragmentation.

In response, the storage control 210 operates the point-in-time copy module 230 to employ the information stored for example in data storage 240 to recover the data using the point-in-time copy from step 430, in step 500. The completed point-in-time copy is stored in data storage 240 and comprises the information needed to identify the data from the data subject to defragmentation. Specifically, the point-in-time copy utilizes the existing metadata and pointers to identify all of the data subject to defragmentation at the time of its creation in step 430, including the data that was “moved” but still exists at the area that it was moved from, and the data that was not moved. Thus the backup comprises the last stable version of the data subject to defragmentation as of the last stable state selected in step 410.

Thus, the recovery process 500 employs the backup copy for establishing the last stable version of the data subject to defragmentation and is placed on top of the partially defragmented data. The user is then able to access the data of the volume immediately, rather than having to run another defragmentation operation to complete the defragmentation job before accessing the data.

A person of ordinary skill in the art will appreciate that the embodiments of the present invention, disclosed herein, including the computer-implemented system 200 for providing point-in-time copies of data during defragmentation of at least one of the data storage devices of FIG. 1, and the functionality provided therein, may be embodied as a system, method or computer program product. Accordingly, embodiments of the present invention may take the form of an entirely hardware embodiment, an entirely software embodiment (including firmware, resident software, micro-code, etc.) or a combination thereof, such as an embodiment combining software and hardware aspects that may all generally be referred to herein as a “circuit,” “module” or “system.” Furthermore, embodiments of the present invention may take the form of a computer program product embodied in one or more computer readable medium(s) having non-transient computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing to become resident in non-transient form.

Computer program code for carrying out operations for embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Those of skill in the art will understand that changes may be made with respect to the methods discussed above, including changes to the ordering of the steps. Further, those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. In a computer-implemented data storage system comprising at least one storage control and data storage, the method comprising:
allowing defragmentation of data with respect to said data storage, said defragmentation comprising analysis and data movement;
during said defragmentation and before completion of said defragmentation, in response to said data movement reaching a stable state, interrupting further said defragmentation analysis and data movement;
making a point-in-time copy of said data subject to said defragmentation; and
resuming said defragmentation analysis and data movement.

2. The method of claim 1, wherein said stable state comprises a temporary state of said storage control and data storage wherein said data movement in accordance with said data analysis is complete.

3. The method of claim 2, wherein said stable state comprises completion of updating a volume table of contents with respect to said data movement.

4. The method of claim 1, wherein said stable state comprises a temporary state of said storage control and data storage wherein said data movement has completed such that it is in synchronization with said data analysis.

5. The method of claim 4, wherein said synchronization comprises, for a volume of said data, during said data movement, determining whether a volume table of contents, VSAM volume data set, and data set extents on the volume are in synchronization.

6. The method of claim 1, wherein, subsequent to an early point-in-time copy and subsequent to said data movement reaching a further stable state, said early point-in-time copy is withdrawn.

7. The method of claim 6, additionally comprising, in response to a premature end to the defragmentation process with respect to said data, recovering said data subject to defragmentation from a most recent said point-in-time copy.

8. A data storage system comprising:
data storage; and
at least one storage control comprising:
an interrupt module allowing defragmentation of data with respect to said data storage, said defragmentation comprising analysis and data movement, said interrupt module, during said defragmentation and before completion of said defragmentation, in response to said data movement reaching a stable state, interrupting further said defragmentation analysis and data movement;
a point-in-time copy module, subsequent to said interrupt module interrupting said defragmentation, making a point-in-time copy of said data subject to said defragmentation; and
said interrupt module resuming said defragmentation analysis and data movement.

9. The data storage system of claim 8, wherein said stable state comprises a temporary state of said storage control and data storage wherein said data movement in accordance with said data analysis is complete.

10. The data storage system of claim 9, wherein said stable state comprises completion of updating a volume table of contents with respect to said data movement.

11. The data storage system of claim 8, wherein said stable state comprises a temporary state of said storage control and data storage wherein said data movement has completed such that it is in synchronization with said data analysis.

12. The data storage system of claim 11, wherein said synchronization comprises, for a volume of said data, during said data movement, determining whether a volume table of contents, VSAM volume data set, and data set extents on the volume are in synchronization.

13. The data storage system of claim 8, wherein said point-in-time copy module, subsequent to an early point-in-time copy and subsequent to said data movement reaching a further stable state, said early point-in-time copy is withdrawn.

14. The data storage system of claim 13, additionally comprising an error recovery module, in response to a premature end to the defragmentation process with respect to said data, recovering said data subject to defragmentation from a most recent said point-in-time copy.

15. A computer program product responsive to defragmentation of data of a data storage system, comprising computer-usable storage medium having non-transient computer-usable program code embodied therein, said computer-usable program code comprising:
computer-usable program code to allow defragmentation of data with respect to said data storage system, said defragmentation comprising analysis and data movement, and during said defragmentation and before completion of said defragmentation, in response to said data movement reaching a stable state, interrupt further said defragmentation analysis and data movement;
computer-usable program code to make a point-in-time copy of said data subject to said defragmentation; and
computer-usable program code to resume said defragmentation analysis and data movement.

16. The computer program product of claim 15, wherein said stable state comprises a temporary state of said storage control and data storage wherein said data movement in accordance with said data analysis is complete.

17. The computer program product of claim 16, wherein said stable state comprises completion of updating a volume table of contents with respect to said data movement.

18. The computer program product of claim 15, wherein said stable state comprises a temporary state of said storage control and data storage wherein said data movement has completed such that it is in synchronization with said data analysis.

19. The computer program product of claim 15, comprising computer-usable program code to, subsequent to an early point-in-time copy and subsequent to said data movement reaching a further stable state, withdraw said early point-in-time copy.

20. The computer program product of claim 19, comprising computer-usable program code to, in response to a premature end to the defragmentation process with respect to said data, recover said data subject to defragmentation from a most recent said point-in-time copy.
